(19) United States
(12) Patent Application Publication
(10) Pub. No.: US 2026/0195584 A1
(43) Pub. Date: Jul. 9, 2026

(54) Method for Training a Neural Network for Determining Features of Objects for Object Tracking

(71) Applicant: Robert Bosch GmbH, Stuttgart (DE)

(72) Inventors: Tillmann Falck, Muenchen (DE); Florian Drews, Renningen (DE); Florian Faion, Staufen (DE); Lars Rosenbaum, Lahntal (DE); Koba Natroshvili, Waldbronn (DE); Claudius Glaeser, Ditzingen (DE)

(21) Appl. No.: 19/128,208

(22) PCT Filed: Oct. 27, 2023
(86) PCT No.: PCT/EP2023/080038

§ 371 Date: May 8, 2025

(30) Foreign Application Priority Data
Nov. 10, 2022 (DE) 10 2022 211 915.0

(51) Int. Cl. G06N 3/08; G06T 7/246

(52) U.S. Cl. CPC G06N 3/08; G06T 7/248; G06T 2207/20081; G06T 2207/20084

(57) ABSTRACT

A method is for training a neural network for determining features of objects for object tracking. The method includes generating a training dataset with a plurality of training data elements. Each training data element has a first set of sensor data relating to a first state of an environment with a set of a plurality of objects and a second set of sensor data relating to a second state of the environment. In the second state, the positions of the objects have at least partially changed compared to the first state. The method also includes determining features of the objects by feeding the first set of sensor data to the neural network and determining features of the objects by feeding the second set of sensor data to the neural network. A loss is determined depending on the generated features, and the neural network is trained to reduce the loss.

### PRIOR ART

The present disclosure relates to methods for training a neural network for determining features of objects for object tracking.

A comprehensive detection of the vehicle environment forms the basis for driver assistance systems and automated driving functions. Detection, classification and tracking of objects, such as other road users, is of particular importance. Nowadays, a variety of sensors are employed to acquire the vehicle environment. This includes, for example, cameras, radars, LiDAR, or ultrasonic systems.

Objects can be tracked via features, called re-ID features. However, they are typically often determined so that they are “globally” and permanently unambiguous (and not just within a scene where object tracking is to be performed), which conversely limits the flexibility of their selection and thus impairs their use for object tracking.

More effective approaches for feature extraction are therefore desirable for object tracking.

### DISCLOSURE OF THE INVENTION

A method is provided for training a neural network for determining features of objects for object tracking, the method comprising:
configuring a neural network with a network architecture, such that, when fed with a set of sensor data containing a sensor data element for each of a plurality of objects, it determines a feature vector for each object depending on all of the sensor data elements;
generating a training dataset with a plurality of training data elements, wherein each training data element has a first set of sensor data relating to a first state of an environment with a set of a plurality of objects and a second set of sensor data relating to a second state of the environment, wherein in the second state, the positions of the objects have at least partially changed compared to the first state;
For each training data element,
   determining features of the objects by feeding the first set of sensor data to the neural network; and
   features of the objects by feeding the second set of sensor data to the neural network;
determining a loss that penalizes, for each training data element, for each object, a deviation between the feature determined by the neural network for the object from the first set of sensor data and the feature determined by the neural network for the object from the second set of sensor data, and penalizes a lack of deviation between the feature determined by the neural network for the object from the first set of sensor data, and, for any of the objects, the feature determined by the neural network for the other object from the second set of sensor data; and
Training the neural network to reduce the loss.

The neural network thus trained can then be used for extraction of (re-ID) features (i.e., as a feature extractor) that are then employed as part of object tracking. The approach described above (e.g., in the embodiments described below) allows for an improved association of measured values to object tracks, which advantageously affects the overall performance of the object trackings, i.e., objects can be tracked more accurately, fewer track breaks occur, and fewer objects are lost (overlooked).

In accordance with the approach described above, it is provided that a scene context (in particular other objects of the same scene) is used for training (and, if necessary, for extraction of re-ID features). This allows scene-specific features to be used to associate measured values with object tracks. In conjunction with this, re-ID features can be extracted that are more suitable for the task of object tracking, which in turn has a positive effect on the overall performance of object tracking. As the extraction of the re-ID features is adapted to the specific requirements of object tracking, the methods may be implemented more computationally efficient (e.g., using smaller neural networks). A network architecture of a class of network architectures is employed that is suitable for extraction of scene-specific re-ID features.

Various exemplary embodiments are specified in the following.

Exemplary embodiment 1 is a method for training a neural network for determining features of objects for object tracking, as described above.

Exemplary embodiment 2 is the method according to exemplary embodiment 1, comprising configuring the neural network with a network architecture, such that, when fed with a set of sensor data, containing a sensor data element for each of a plurality of objects, it performs the feature vector via multi-stage processing, wherein at least one step generates feature components for each of the objects, max-pooling of the feature components via the objects, and the feature components and the result of max-pooling of the feature components are fed to the following step.

In this way, the neural network determines a feature vector for each object depending on all of the sensor data elements, i.e., it takes the other objects into account when determining a feature vector for an object, i.e., it determines the feature vectors based on a local context (sensor data elements of the individual object) as well as a global context of the objects (result of max-pooling across the objects). Alternatively, a transformer network may be employed.

Exemplary embodiment 3 is the method according to exemplary embodiment 1 or 2, wherein each training data element contains information about which object in the first state corresponds to which object in the second state, the determined features of the objects are used to determine which objects in the first state correspond to which objects in the second state, and the loss is determined by comparing the information contained in the training data elements about which object in the first state corresponds to which object in the second state with the result of the determination based on the determined features of which objects in the first state correspond to which objects in the second state.

The association of objects (e.g., in the form of an association matrix) can thus be provided as a ground truth. This trains the neural network to select features that are particularly well-suited for object tracking. For example, the result of determining which objects in the first state correspond to which objects in the second state based on the determined features is a soft association matrix.

Exemplary embodiment 4 is a method for tracking objects, comprising
acquiring sensor data of a first set of objects at a first time point;
acquiring sensor data of a second set of objects at a second time point;
feeding the sensor data of the first set of objects to the neural network trained according to any of exemplary embodiments 1 to 3 to generate first features;
feeding the sensor data of the second set of objects to the trained neural network to generate second features; and
pairwise association of objects of the first set of objects of the second set using the first features and the second features.

Exemplary embodiment 5 is the method according to exemplary embodiment 4, comprising acquiring sensor data of objects in a scene at the first time point, grouping the objects into a plurality of first groups based on their local proximity, selecting one of the first groups as the first set of objects, acquiring sensor data of objects in the scene at the second time point, grouping the objects into a plurality of second groups based on their proximity, and selecting one of the second groups as the second set of objects, such that the second set of objects is the second group closest to the first set of objects within the scene.

Objects in scenes are thus treated as (local) clusters. This facilitates the differentiation of the features based on the features, since not all objects in a scene need to be differentiated, but only those of a group.

Exemplary embodiment 6 is a data processing device (e.g., a control device) which is set up to perform a method according to any of exemplary embodiments 1 to 5.

Exemplary embodiment 7 is a computer program with instructions that, when executed by a processor, cause the processor to carry out a method according to any of exemplary embodiments 1 to 5.

Exemplary embodiment 8 is a computer-readable medium that stores instructions that, when executed by a processor, cause the processor to perform a method according to any of exemplary embodiments 1 to 5.

In the drawings, similar reference signs generally refer to the same parts throughout the different views. The drawings are not necessarily to scale, wherein emphasis is instead generally placed on representing the principles of the invention. In the following description, various aspects are described with reference to the following drawings.

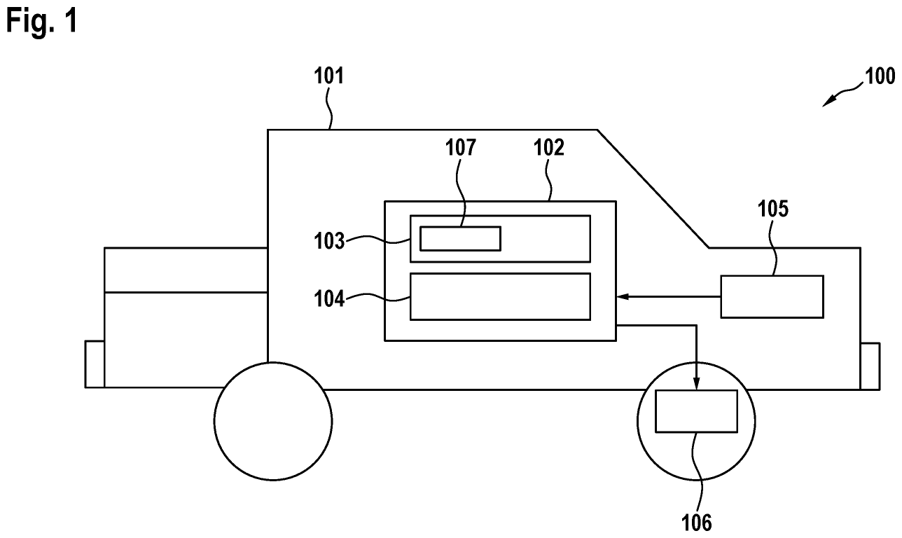

FIG. 1 shows a vehicle.

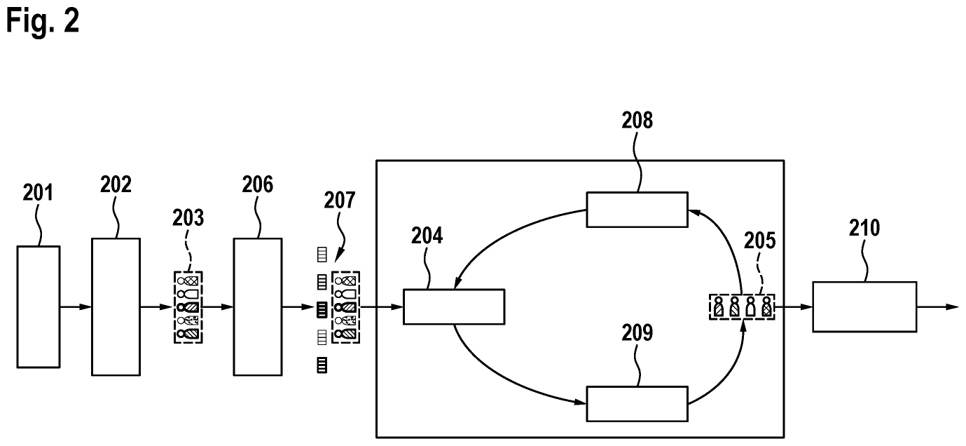

FIG. 2 illustrates the object tracking by means of re-ID features.

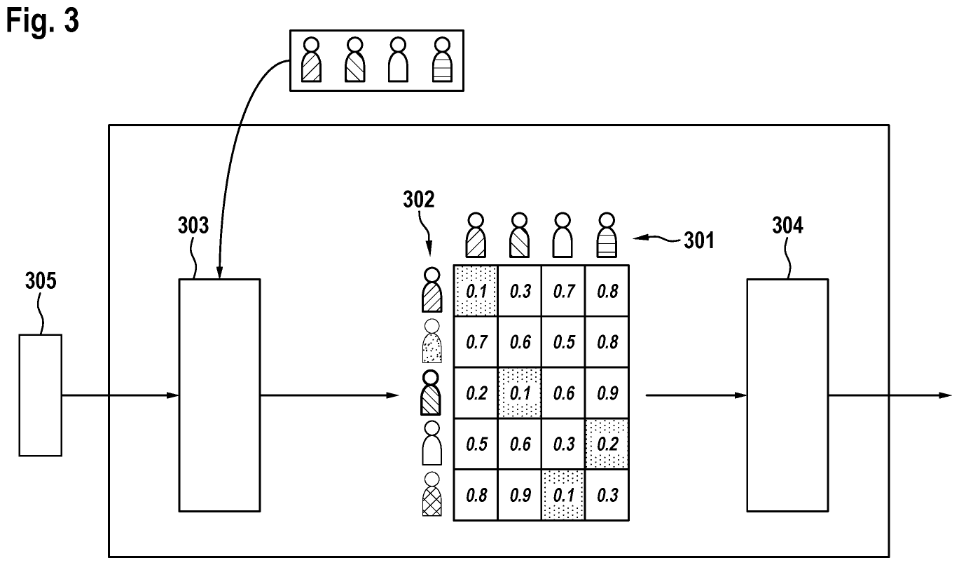

FIG. 3 illustrates the association of tracked objects with currently acquired objects.

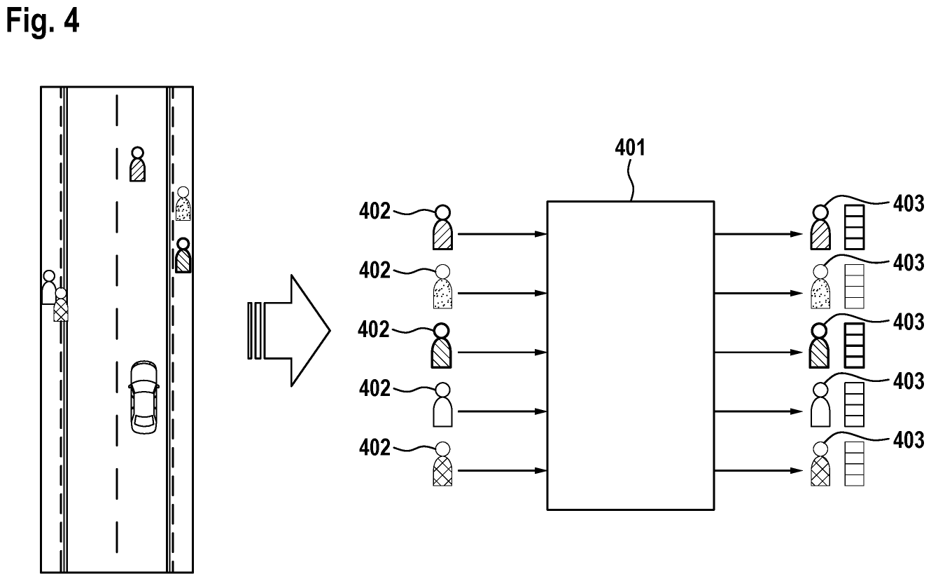

FIG. 4 illustrates a feature extraction according to one embodiment.

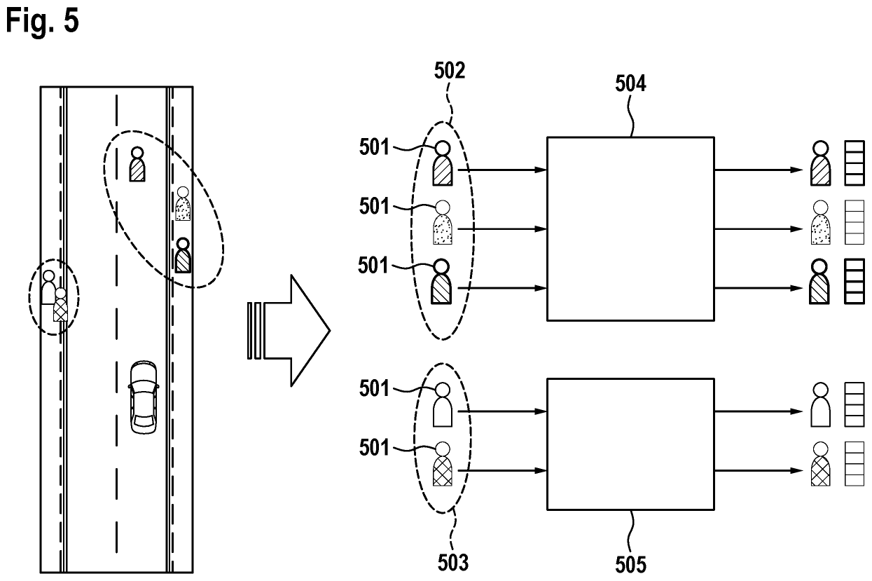

FIG. 5 illustrates feature extraction according to another embodiment.

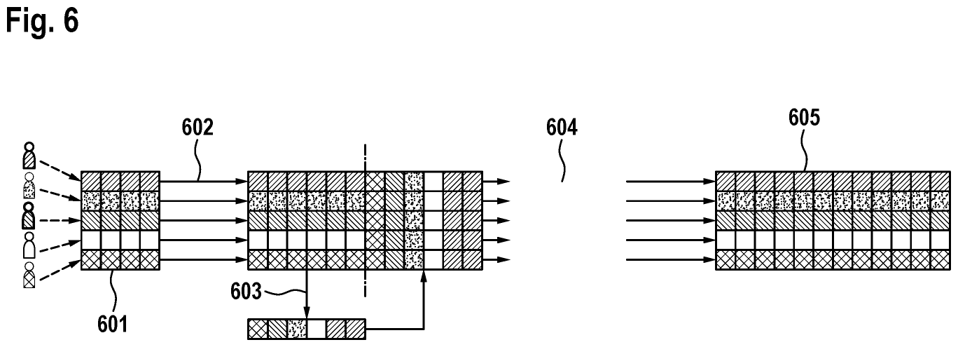

FIG. 6 shows a possible architecture of a neural network for re-ID feature extraction.

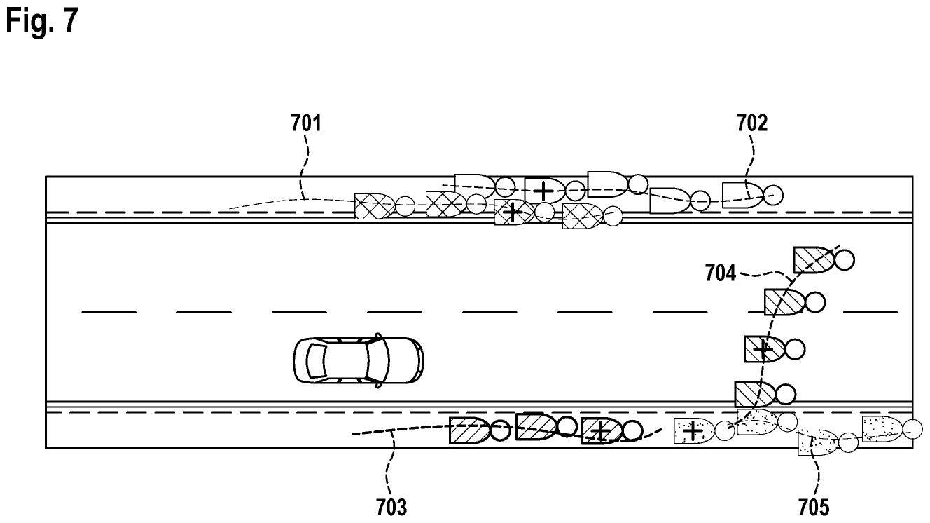

FIG. 7 shows an example in which trajectories of pedestrians are depicted, which can be used to train a re-ID feature extractor.

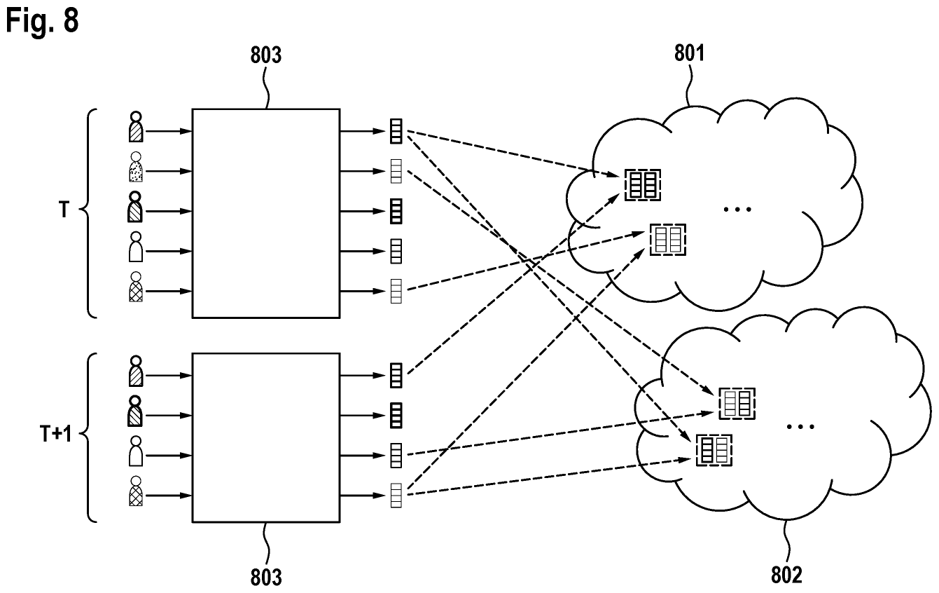

FIG. 8 shows how to form sets of positive re-ID feature pairs and negative re-ID feature pairs based on which various losses (cost functions) may be calculated for training a Re-ID feature extractor.

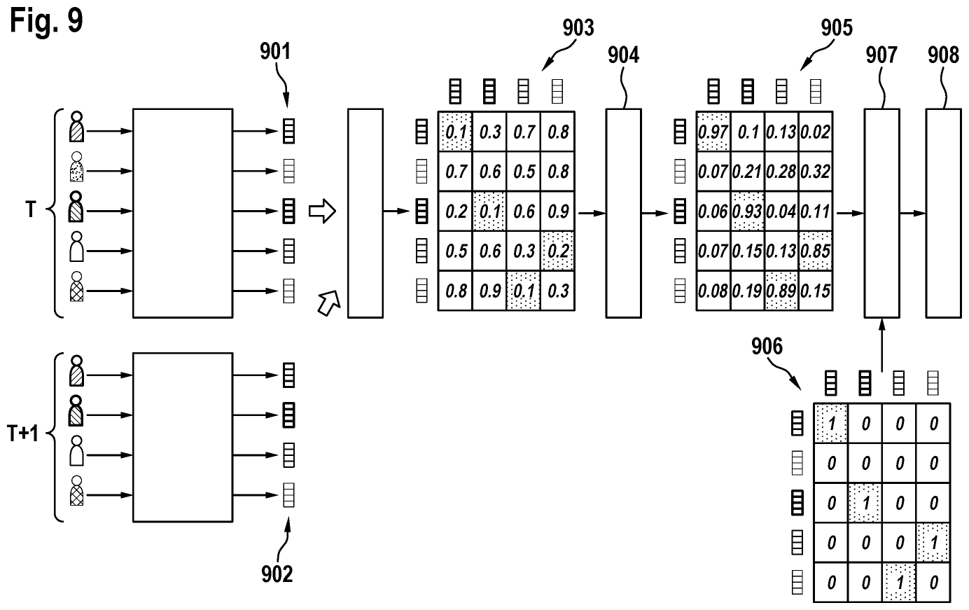

FIG. 9 illustrates a method for training a re-ID feature extractor, wherein the loss is calculated based on a calculated association between measured values of successive measurement times.

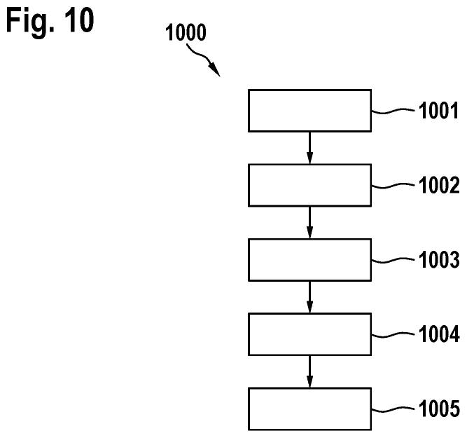

FIG. 10 shows a flow chart illustrating a method for training a neural network for determining features of objects for object tracking.

The following detailed description relates to the accompanying drawings, which, for clarification, show specific details and aspects of this disclosure in which the invention may be implemented. Other aspects may be used, and structural, logical and electrical changes may be performed without departing from the scope of protection of the invention. The various aspects of this disclosure are not necessarily mutually exclusive since some aspects of this disclosure may be combined with one or a plurality of other aspects of this disclosure to form new aspects.

Different examples will be described in more detail in the following.

FIG. 1 shows an (e.g., autonomous) vehicle 101.

In the example of FIG. 1, the vehicle 101, for example a car or truck, is equipped with a vehicle control device 102.

The vehicle control device 102 has data processing components, e.g., a processor (e.g., a CPU (central processing unit)) 103 and a memory 104 for storing control software according to which the vehicle control device 102 operates, and data processed by the processor 103.

For example, the stored control software (computer program) has instructions that, when executed by the processor, cause the processor 103 to implement one or a plurality of neural networks 107.

The data stored in the memory 104 may, for example, include image data captured by one or a plurality of cameras 105. For example, the one or the plurality of cameras 105 may take one or a plurality of grayscale photographs or color photographs of the surroundings of the vehicle 101.

Based on the image data, the vehicle control device 102 can determine whether and which objects, e.g., fixed objects such as traffic signs or road markings or moving objects such as pedestrians, animals and other vehicles, are present in the surroundings of the vehicle 101.

Image data is herein provided as an example of sensor data only, and data from other sensors (ultrasound, LiDAR, etc.) may also be used.

The vehicle 101 can then be controlled by the vehicle control device 102 according to the results of the object detection. For example, the vehicle control device 102 may control an actuator 106 (e.g., a brake) in order to control the speed of the vehicle, e.g., to brake the vehicle.

To this end, it is typically desirable not only to detect objects, but also to track them, for example to predict their later position by looking at how they have moved in the past and to gain a consistent understanding of the current (traffic) situation.

For example, tracking of objects is implemented with recursive filters (e.g., Kalman Filter), which perform three processing steps: Prediction, association and update. During prediction, existing objects are initially predicated to the current measurement time using motion models. Current measurements (for example, object detection in camera images) are then associated with the predicted objects. Finally, the predicted objects are corrected using the associated measurements in an update step. In particular, the association of measurements to object tracks is important because erroneous associations lead to inaccurate object tracks or even the loss of object tracks. The association is based on distance metrics that map the proximity of measurements and tracked objects in a feature space. Metrics used are, for example, the Euclidean distance or the Mahalanobis distance. Typically, geometric features such as object location, object size, or object velocity are utilized for distance calculation. Measured values are then assigned to tracked objects based on the calculated distances using an association algorithm. Examples of such algorithms are the Hungarian algorithm or various features of the Nearest Neighbor algorithm. Due to the significant influence of the geometric features, problems occur primarily when measurements and objects in these dimensions cannot be clearly associated with one another (e.g., pedestrian groups standing close together, inaccurate predictions due to prolonged occlusions, etc.). The aforementioned problems during association can be mitigated or entirely prevented by adding suitable features. Features are considered suitable if they support a clear association of measurements to objects. For example, these may be view-based features describing the appearance of the objects (example: if only one pedestrian from a pedestrian group is wearing a red jacket, then the red jacket is a good feature to track that pedestrian).

The extraction of so-called re-identification features (re-ID features for short) is used to support object tracking, e.g., in surveillance systems for railroad stations, airports or pedestrian zones, in order to be able to recognize people in different cameras even over extended periods.

FIG. 2 illustrates the object tracking by means of re-ID features.

For this purpose, measured values 203 (which are determined from sensor data, e.g., camera data 201 by pre-processing 202) are enriched with re-ID features obtained from a feature extraction 206 to extended measured values 207 before the association 204 with tracked objects 205, so that the subsequent association 204 (and in particular the distance calculation) can be carried out both on the basis of the geometric features and on the basis of the re-ID features. Current acquired objects (corresponding to measured values 203) are thereby associated with the prediction 208 of tracked objects 205 (and subsequently an update 209 of tracked objects 205). This provides tracking information 210 (e.g., in the form of trajectories) about the acquired objects as output.

FIG. 3 illustrates the association of tracked objects 301 with currently acquired (“measured”) objects 302 (from measured values 305, e.g., detections as object bounding boxes) via a distance calculation 303 using an association algorithm 304. The distance calculation can be based on the geometric features typically used (position, size, speed, etc.) and/or re.ID features.

The re-ID features are typically extracted using deep neural networks (e.g., one of the neural networks 107). The basis for training corresponding networks are large annotated datasets containing numerous objects (e.g., persons) with a variety of views per object. The goal of the training is to find appropriate weights for the neural network, so that a feature space suitable for the re-identification of the objects is created (in which the neural network maps inputs (e.g., views of objects)), i.e., different views of the same object (e.g., the same person) should be mapped to features (feature vectors), which have a small distance in the feature space, whereas the distances to feature vectors to which views of other objects are mapped should be maximized.

A feature map trained in this way (feature extraction) is suitable for recognizing objects from a large database and can thus also be helpful for association during tracking.

In detail, re-ID features for use during object tracking should have the following properties:
Scene-specific features: The features should be suitable for distinguishing objects from other objects within the same scene. For this purpose, it is not necessary for an object to be distinguishable from all objects (also other scenes). However, typical methods for extracting re-ID features only perform the latter. Referring to the foregoing example: If a person is the only one in a scene wearing a red jacket, the red jacket is a good feature to distinguish the person from other people in the scene. A red jacket is certainly not a good feature for distinguishing one person from all the other people around the world. This means that other features may be suitable for tracking applications than for classical re-ID applications. Moreover, the features for the same person may be different on a scene-specific basis. Depending on the context of the scene, in one case it may be the red jacket, and a little later be the umbrella being carried (e.g., if a second person enters the scene wearing a red jacket).
Consistency over a short period of time: With object tracking, objects only need to be recognized over a small time horizon. Typically, only from one measurement point to the next (a few milliseconds). In the case of occlusions, it may be necessary to recognize objects within a few seconds. Thus, it is only necessary for the re-ID feature for an object to be nearly constant within that short time period, but not over minutes, hours, or days. For example, a person only needs to be recognized within a scene and distinguished from other people. When the same person reappears in another scene, it is not necessary to know that they are the same person.

In view of the above desired properties of a feature extraction (i.e., feature extraction requirements), according to various embodiments, an approach is provided that enables improved object tracking by improving the association of measured values (e.g., object detections) to object tracks (i.e., tracked objects) and thus improved object tracking. An improvement in object tracking is reflected in more accurate object trajectories, fewer track breaks, and fewer object losses.

Re-ID features are used to improve the association during object tracking (e.g., as described with reference to FIGS. 1 to 3). However, the training and extraction of the re-ID features are aligned to the specific requirements for feature extraction (as described above). In particular, according to various embodiments, a method is provided for extracting re-ID features during tracking, specific network architectures for re-ID feature extractors, and methods for training suitable re-ID feature extractors.

Usual methods for extracting re-ID features train corresponding deep neural networks on large annotated datasets with the goal of being able to delineate different views of an object (e.g., one person) from views of other objects (e.g., all other persons). A fully trained neural network is then individually applied to each detected object to generate re-ID features for that object, i.e., if for example, five people were detected in a scene, the network is executed five times independently (once for each detection).

In contrast, according to various embodiments, an approach is provided as illustrated in FIG. 4.

FIG. 4 illustrates a feature extraction according to one embodiment.

Here, a re-ID feature extractor 401 (neuronal network) is used, which uses a plurality of measured values (e.g., detections) 402 as input and generates associated re-ID feature vectors 403 as output for the plurality of measured values 402. This procedure enables the feature extractor 401 to extract scene-specific features—i.e., features that are particularly suitable for distinguishing or recognizing the measured values of the scene (in the example to distinguish the five people).

This implies that the scene context plays a major role in the extraction of the features. Referring to the example of the red jacket above: if only one person is wearing a red jacket in the scene, the red jacket will be a good feature for recognition. If there are several persons with red jackets in the scene, the feature extractor will include other features for differentiation or recognition of the persons (e.g., hair color, umbrella that is carried, etc.).

FIG. 5 illustrates feature extraction according to another embodiment.

According to the embodiment of FIG. 5, measured values of a scene 501 are first grouped (whispered) into clusters 502, 503 and then feature extraction 504, 505 is performed per cluster 502, 503. This has the advantage that re-ID feature extraction can be concentrated on the measured values for which there is a high risk of incorrect association (e.g., groups of pedestrians standing close together). With reference to the above example of the red jacket: even if there are two people with red jackets in a scene, a red jacket may be a suitable feature for distinguishing recognition from the other people (and thus recognition), e.g., if the two people with red jackets are far apart (e.g., on different sides of the road) and thus belong to different clusters 502, 503.

According to another embodiment, it is provided that the re-ID feature extraction takes into account a weighting of the measured values. In detail, the weights are intended to reflect how much individual measured values should be distinguishable from other measured values. The re-ID feature extraction can then focus on extracting suitable distinguishing features. For example, weights can be specified in pairs (between all measured values) so that each weight indicates how important a differentiation between the two measured values.

For example, the weights reflect the separability based on the geometric features (such as position, extension, speed), i.e., poorly separable measured values receive a high weight. What is described with reference to FIG. 5 can be seen (or implemented) as a special case of such weighting: pairwise weights are 1 for all pairs of measured values of the same cluster, 0 otherwise.

According to various embodiments, a neural network for re-ID feature extraction (to be applied in the manner noted above), utilizes an architecture that satisfies the following features:
The input may include any number of N measured readings in the form of N input data vectors (which may also be considered input feature vectors). Measured values may be, for example, detections of pedestrians whose input vectors contain, for example, associated raw sensor data (image pixels, LiDAR point clouds, radar reflections, etc.) or variables derived therefrom.
The N measured values may be entered in any order, i.e., the calculation of the re-ID features is independent of the sequence.
The output of the network is N re-ID feature vectors, wherein N corresponds to the number of input measured values.

FIG. 6 shows a possible architecture of a neural network for re-ID feature extraction.

The input of the network is the measured values 601 (e.g., pedestrian detections). The measured values are unordered (because the order should be irrelevant for the extracted features). Each measured value is characterized by certain features in the form of an input data vector (e.g., raw sensor data for the detections such as image pixels, LiDAR points, radar reflections, or data derived therefrom). The output 605 of the network corresponds to the calculated re-ID feature vectors (i.e., a feature vector for each measured value of input 601).

The first layer 602 processes the data of each measured value independently of each other using a measured value-wise fully meshed layer (1D-conv). This layer is characterized by a weight matrix M and a bias vector b. To get from the input representation (measured value data) to the first hidden layer, the same weight matrix M and the same bias vector b are used for each measured value (so-called weight-sharing). The output of such 1D-conv layers is a new representation of the measured value-wise data (measured value-specific local characteristic vectors). A 1D-conv layer thus operates locally, in which only the features within a measured value are combined with one another (local context). In the example, a 1D-conv layer extracts individual features (e.g., regarding their shape, color, etc.) for each pedestrian.

A pooling layer 603 follows, which reduces the measurement-wise features to a single (so-called global) feature. In the illustrated example, the maximum of the features of the first hidden layer is calculated (global max-pooling). Such a pooling layer aggregates information across several measured values, thereby allowing dependencies between the measured values (global context) to be mapped, i.e., the pooling layer 603 allows the features previously individually extracted for each pedestrian to be combined with each other and place in relation to each other.

In order to use this global relationship between the features in the further calculation, the global feature vector can be appended to the measured value-specific local feature vectors. Subsequent 1D-conv layers 604 (similar to the first layer 602, possibly together with a respective max-pooling layer 603) can consequently also access the global context in their measurement-wise feature extraction. For example: Features that distinguish the individual pedestrians may be highlighted.

As shown in FIG. 6, it is possible for multiple 1D-conv+pooling+append processing blocks to be sequenced together to ultimately extract complex re-ID feature vectors 605.

The architecture shown in FIG. 6 is a specific realization, which can be varied. A generalized base architecture can be described as follows:
An unordered list of measured values is used as an input. The output of the network architecture is a list of re-ID feature vectors (one output vector per input measurement value).
The architecture utilizes any number of layers on which a measured value-wise extraction of (local) features is performed. In one embodiment, a weight-sharing is implemented in the measured value-wise feature extraction.
The architecture includes at least one global pooling layer that combines the measured-value-wise extracted local features into a global feature vector. Moreover, further pooling operators may be used according to the various measured value-wise feature extraction layers. In one embodiment, the pooling layers use the max pooling operator. However, other pooling operators (for example average pooling) are also contemplated.
The architecture uses at least one concatenation module (append) which merges global (pooled) feature vectors with the local (measured value) feature vectors.

Various extensions are possible for the described base architecture, for example:
Global feature vector: The pooled feature vector can be further processed as desired prior to concatenation with the local feature vectors, e.g., with the aid of fully meshed layers.
Order: Even in later layers, (local or global) features from earlier layers may be used directly, e.g., with the help of so-called skip connections.

The re-ID feature extractor training is based on datasets in which trajectories of objects are annotated. This means that objects are annotated in individual measurement times and an association exists between the measurement times (e.g., using object IDs).

FIG. 7 shows an example in which trajectories 701 to 705 of pedestrians are depicted, which can be used to train a re-ID feature extractor.

The pedestrians marked with “+” refer to the same sensor measurement time. Moreover, annotations of the pedestrians at earlier and later measurement times are shown.

FIG. 8 shows how to form sets of positive re-ID feature pairs 801 and negative re-ID feature pairs 802 based on which various losses (cost functions) may be calculated for training a Re-ID feature extractor 803.

As shown in FIG. 8, for training according to various embodiments, it is provided that the re-ID feature extraction is applied to at least two consecutive measurement times and the set of positive pairs 801 and the set of negative pairs 802 are formed from the resulting re-ID feature vectors.

Positive pairs correspond to two feature vectors that describe the same object (e.g., a pedestrian) at different measurement times. Negative pairs correspond to two feature vectors that describe different objects (e.g., two different pedestrians) at the same or different measurement times. Whether feature vectors describe different or the same object is known for the training data of the training dataset (through corresponding annotation of the input data vectors containing the training dataset).

When this procedure is applied to a plurality of short sequences (i.e., successive measurement times) of the annotated training dataset, large amounts of positive and negative pairs may be generated.

When training, the weights of the neural network are adapted in such a way that the distance between the feature vectors of positive pairs is reduced (ideally minimized), whereas a distance between the feature vectors of negative pairs is increased (ideally maximized). This may be implemented, for example, with the aid of reverse propagation of a suitable loss (cost function) and gradient decline. For example, a contrast loss, triplet loss, multiclass N pair loss, or constellation loss is used as a cost function.

Training of the neural network is thus carried out, for example, as follows:
1) Generate multiple sequences consisting of two or more measurement time points
2) Calculating re-ID Feature vectors by applying the neural network
3) Generating positive and negative pairs of the calculated re-ID feature vectors
4) Calculating the loss
5) Adapting network weights by reverse propagation of loss and gradient decline.

The above training steps 1) to 5) may be repeated as many times as desired.

According to a further embodiment, it is provided that the weights of the neural network are adjusted based on a loss that reflects the grade of association between measured values of two consecutive time steps.

FIG. 9 illustrates a method for training a re-ID feature extractor, wherein the loss is calculated based on a calculated association between measured values of successive measurement times.

To this end, for two successive time steps, first the re-ID feature vectors 901, 902 of the measured values are extracted, then a distance matrix 903 is calculated, and on the basis of which a soft association matrix 905 is calculated by a differentiable association module 904 (e.g., Deep Hungarian Network). “Soft” refers to the fact that its entries (association values) approximate the binary entries (i.e., 0 or 1) of a real association matrix. Finally, by comparing the soft association matrix with the real association matrix (which is known from the labels, i.e., annotations, of the training dataset), a loss 907 can be calculated based on which the network weights can be adjusted by reverse propagation and gradient decline 908.

It should be noted that this loss also penalizes it if different features are assigned to the same object or different features are assigned to different objects, as the soft association matrix then has correspondingly low association values for the same objects or has high association values for different objects.

In summary, according to various embodiments, a method as shown in FIG. 10 is provided.

FIG. 10 shows a flow chart 1000 illustrating a method for training a neural network for determining features of objects for object tracking.

In 1001, a neural network with a network architecture is configured (i.e., a neural network with such an architecture is provided), such that, when fed with a set of sensor data containing a sensor data element for each of a plurality of objects, it determines a feature vector for each object depending on all of the sensor data elements.

In 1002, a training dataset with a plurality of training data elements is generated, wherein each training data element has a first set of sensor data relating to a first state of an environment with a set of a plurality of objects and a second set of sensor data relating to a second state of the environment, wherein in the second state, the positions of the objects have at least partially changed compared to the first state.

In 1003, features of the objects are determined for each training data element by feeding the first set of sensor data to the neural network and features of the objects are determined by feeding the second set of sensor data to the neural network.

In 1004, a loss is determined that penalizes, for each training data element, for each object, a deviation between the feature determined by the neural network for the object from the first set of sensor data and the feature determined by the neural network for the object from the second set of sensor data, and penalizes a lack of deviation between the feature determined by the neural network for the object from the first set of sensor data, and, for any of the objects, the feature determined by the neural network for the other object from the second set of sensor data.

In 1005, the neural network is trained to reduce the loss.

Here, 1003, 1004, and 1005 can occur repeatedly, for example, the loss is determined for batches of training data elements (i.e., the training dataset may have, for example, batches each having a plurality of training data elements (of the form described) for each of which a loss is generated and the neural network is trained for each batch to reduce the respective loss).

The method according to FIG. 10 may be performed by one or a plurality of computers comprising one or a plurality of data processing units. The term “data processing unit” may be understood to mean any type of entity that enables the processing of data or signals. The data or signals may, for example, be processed according to at least one (i.e., one or more than one) specific function performed by the data processing unit. A data processing unit may comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail here may also be understood as a data processing unit or logic circuit array. One or a plurality of the method steps described in detail here may be carried out (e.g., implemented) by a data processing unit by means of one or a plurality of specific functions performed by the data processing unit.

According to various embodiments, the method is thus, in particular, computer-implemented.

After training, the neural network may be applied to sensor data determined from at least one sensor to obtain features that are then used for object tracking. The result of the object tracking may then be used to control a robotic device.

For example, after the training, the neural network is used to generate a control signal for a robotic device by feeding the machine learning model with sensor data relating to the robotic device and/or its environment. The term “robotic device” can be understood as relating to any technical system (with a mechanical part whose movement is controlled), such as a computer-controlled machine, a vehicle, a household appliance, an electric tool, a manufacturing machine, a personal assistant, or an access control system.

Various embodiments may receive and use sensor data from various sensors, such as video, radar, LiDAR, ultrasound, motion, thermal imaging, etc.

Although specific embodiments have been illustrated and described here, a person skilled in the art in the field will recognize that the specific embodiments shown and described may be exchanged for a variety of alternative and/or equivalent implementations without departing from the scope of protection of the present invention. This application is intended to cover any modifications or variations of the specific embodiments discussed here. It is therefore intended that the present invention be limited only by the claims and the equivalents thereof.

1. A method for training a neural network for determining features of objects for object tracking, the method comprising:
configuring a neural network with a network architecture, such that, when the neural network is fed with a set of sensor data containing a sensor data element for each of a plurality of objects, the neural network determines a feature vector for each object of the plurality of objects depending on all of the sensor data elements;
generating a training dataset with a plurality of training data elements, wherein each training data element has a first set of sensor data relating to a first state of an environment with a set of a plurality of objects and a second set of sensor data relating to a second state of the environment, wherein in the second state, positions of the objects have at least partially changed compared to the first state;
for each training data element,
determining features of the objects by feeding the first set of sensor data to the neural network; and
determining features of the objects by feeding the second set of sensor data to the neural network;
determining a loss that penalizes, for each training data element, for each object, a deviation between (i) the feature determined by the neural network for the object from the first set of sensor data, and (ii) the feature determined by the neural network for the object from the second set of sensor data, and that penalizes a lack of deviation between (i) the feature determined by the neural network for the object from the first set of sensor data, and, (ii) for any of the objects, the feature determined by the neural network for the other object from the second set of sensor data; and
training the neural network to reduce the determined loss.

2. The method according to claim 1, further comprising:
configuring the neural network with the network architecture, such that, when the neural network is fed with a set of sensor data, containing a sensor data element for each of a plurality of objects, the neural network performs the feature vector via multi-stage processing,
wherein at least one step generates feature components for each of the objects, max-pooling of the feature components via the objects, and the feature components and a result of max-pooling of the feature components are fed to a following step.

3. The method according to claim 1, wherein:
each training data element contains information about which object in the first state corresponds to which object in the second state,
the determined features of the objects are used to determine which objects in the first state correspond to which objects in the second state, and
the loss is determined by comparing the information contained in the training data elements about which object in the first state corresponds to which object in the second state with a result of the determination based on the determined features of which objects in the first state correspond to which objects in the second state.

4. A method for tracking objects, comprising:
acquiring sensor data of a first set of objects at a first time point;
acquiring sensor data of a second set of objects at a second time point;
feeding the sensor data of the first set of objects to a neural network trained according to the method claim 1 to generate first features;
feeding the sensor data of the second set of objects to the trained neural network to generate second features; and
performing pairwise association of objects of the first set of objects of the second set using the first features and the second features.

5. The method according to claim 4, comprising:
acquiring sensor data of objects in a scene at the first time point,
grouping the objects into a plurality of first groups based on their local proximity,
selecting one of the first groups as the first set of objects,
acquiring sensor data of objects in the scene at the second time point,
grouping the objects into a plurality of second groups based on their proximity, and
selecting one of the second groups as the second set of objects, such that the second set of objects is the second group closest to the first set of objects within the scene.

6. The method according to claim 1, wherein a data processing unit is configured to perform the method.

7. The method according to claim 1, wherein a computer program includes instructions that, when executed by a processor, cause the processor to carry out the method.

8. A non-transitory computer-readable medium configured to store instructions that, when executed by a processor, cause the processor to carry out the method according to claim 1.
